(19) United States
(12) Patent Application Publication
(10) Pub. No.: US 2019/0188309 A1
(43) Pub. Date: Jun. 20, 2019

(54) TRACKING CHANGES IN MIRRORED DATABASES

(71) Applicant: International Business Machines Corporation, Armonk, NY (US)

(72) Inventors: Mark J. Anderson, Oronoco, MN (US); David G. Carlson, Rochester, MN (US); Dan A. Christy, Rochester, MN (US); Thomas P. Giordano, Rochester, MN (US); David F. Owen, Rochester, MN (US)

(21) Appl. No.: 15/842,174

(22) Filed: Dec. 14, 2017

(51) Int. Cl. G06F 17/30; G06F 3/06; G06F 11/20

(52) U.S. Cl. CPC G06F 17/30575; G06F 17/30368; G06F 17/30979; G06F 11/2082; G06F 17/30997; G06F 3/065; G06F 17/30144

(57) ABSTRACT

A system and a method for keeping two versions of a mirrored database in sync is provided. A connection is monitored between a primary database and a secondary database. When a loss of the connection between the primary database and the secondary database is detected, the primary database is monitored for changes. When a modification is detected to at least one row in the primary database, a value of a change indicator is changed for the corresponding row indicating that the row was modified. Once the connection between the primary and the secondary databases is restored, the primary database is queried for the value of the change indicator indicating the corresponding row was modified to obtain a current value for data in the corresponding row of the primary database, and the corresponding row in the secondary database is updated with the current value for the corresponding row.

### BACKGROUND

The present disclosure relates to tracking changes in mirrored databases when a connection between the primary and secondary databases fails.

Databases, are any collection of data, or information, that is specially organized for rapid search and retrieval by a computer. Databases are structured to facilitate the storage, retrieval, modification, and deletion of data in conjunction with various data-processing operations. A database management system (DBMS) extracts information from the database in response to queries. Mirrored databases provide redundancy to handle an outage of the primary database. In mirrored databases, an identical version of the primary database is maintained so that interaction can be transferred to the secondary database in the event of an outage at the primary database. As such it is necessary to maintain consistency between the primary and secondary databases.

### SUMMARY

According to embodiments of the present disclosure, a system and a method for keeping two versions of a mirrored database in sync is provided. A connection is monitored between a primary database and a secondary database, wherein the secondary database is a mirrored version of the primary database. When a loss of the connection between the primary database and the secondary database is detected, the primary database is monitored for changes. When modification is detected to at least one row in the primary database, a value of a change indicator is changed for the corresponding row to indicate that the row has been modified. Once the connection between the primary and the secondary databases is restored, the primary database is queried for the value of the change indicator indicating the corresponding row has been modified to obtain a current value for data in the corresponding row of the primary database, and the corresponding row in the secondary database is updated with the current value for the corresponding row of the primary database.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram illustrating components of a mirrored database system according to illustrative embodiments.

FIG. 2 is a flow diagram illustrating a process for monitoring and determining changes when a connection between the primary and secondary databases fails according to an illustrative embodiment.

FIG. 3 is a block diagram illustrating a computing system according to one embodiment.

FIG. 4 is a diagrammatic representation of an illustrative cloud computing environment.

FIG. 5 illustrates a set of functional abstraction layers provided by cloud computing environment according to one illustrative embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to tracking changes in mirrored databases when a connection between the primary and secondary databases fails. While the present disclosure is not necessarily limited to such applications, various aspects of the disclosure may be appreciated through a discussion of various examples using this context.

Current database systems track row changes using a log, or a row change timestamp. Each of these approaches has its advantages for auditing and the like. However, when a database loses synchronization with its secondary database, significant time can be spent rebuilding the secondary database as all records are rebuilt from the transaction logs of the primary database.

In a mirrored system, when one system experiences an outage or some other break in the mirror connection (e.g. a communications failure), the other system will still continue to function. When this occurs, the primary option to track row changes is to log each and every row change once there is a break in the mirror connection. The logs can then be sent to the out-of-date system once it is back up and operational, and the changes can be instituted from the logs. The problem with this approach is that logs consume space and over time, they will continue to grow as more row changes occur. Rows can be changed multiple times, and each update requires an additional log entry, consuming more space. If the target system is down long enough, those logs could grow to be larger than the database itself. As such, it is necessary to ensure adequate storage for the logs in the event of an extended outage. And logging also incurs additional CPU overhead, thus adversely affecting performance of the system. But rows could be changed multiple times, but it may not be necessary to replay every single change to a row onto the target system. For a replicated mirror it is only necessary to ensure that the current state of the row on the system that remained active (the source) is present on the system that experienced the outage (the target). Thus, it is only necessary, to rebuild the database to identify which rows have changed since the failure or outage by updating those rows on the target system with the current value/latest value of the corresponding row on the source system. One solution would be to employ some sort of bitmap on the source system that identifies which rows within the database have changed. But in order to do this the bitmap must be large enough to accommodate every row in the database. This also requires significant storage, although not as much storage as logging. Also, there exists a potential for the source system to experience an outage, and the possibility that a row change floats out to disk before the bitmap update goes to disk. Ensuring that the bitmap gets to disk before the row change also incurs a performance penalty, as it requires two writes to disk instead of one, and ordering of those writes is important.

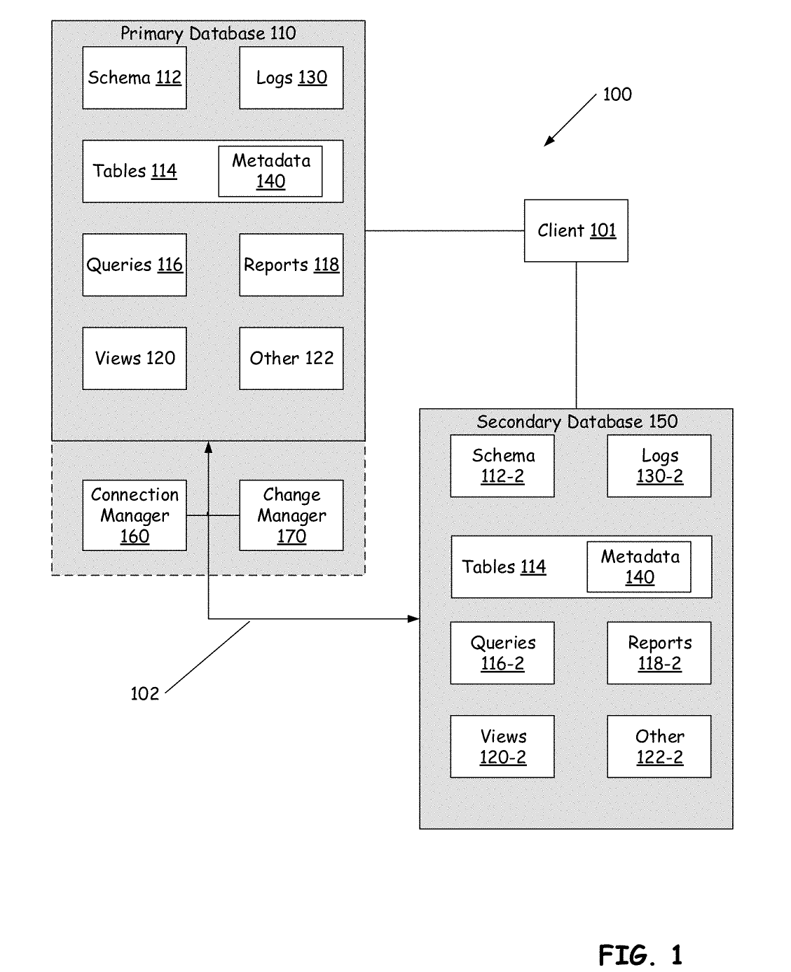

FIG. 1 is a block diagram illustrating a mirrored database system according to an illustrative embodiment. System 100 includes a primary database 110, a secondary database 150, a connection manager 160, and a change manager 170.

The primary database 110 and the secondary database 150 can be any type of database, such as a relational database, non-relational, navigational, etc. Further, the primary database 110 and secondary database 150 can implement any database managements system, such as SQL, DB2, Sybase, NoSQL, MySQL, etc. The only requirement is that the primary database 110 and the secondary database 150 are of the same database type and operate using the same database management system. Database 150 is a mirrored version of the primary database 110. That is database 150 contains a copy of all of the data that is held by database 110. This includes for example, in a relational database, the instances of the schemas 112, tables 114, queries 116, reports 118, views 120, other elements 122 (any other features/elements that may be present in the database), logs 130, and metadata 140 that are present in the primary database 110 (indicated by a -2 following the corresponding reference number). The particular components found within the database are known to those of ordinary skill in the art, and the specifics of these components will not be discussed in further detail except where they are modified or otherwise operate differently.

The primary database 110 and the secondary database 150 are communicatively coupled via connection 102 with each other to enable the database mirroring. The connection 102 can be maintained over a network, such as the Internet, an intranet or any other type of network. Database mirroring maintains two copies of a single database that must reside on different server instances. Typically, these server instances reside on computers in different locations. One server instance serves the database to clients 101 (e.g. the primary database 110). The other instance acts as a hot or warm standby server (e.g. the secondary database 150), depending on the configuration and state of the mirroring session. When a database mirroring session is synchronized, database mirroring provides a hot standby server that supports rapid failover without a loss of data from committed transactions. When the session is not synchronized, the mirror server is typically available as a warm standby server with possible data loss.

The primary and secondary databases 110 and 150 communicate and cooperate as partners in a database mirroring session. The partner that owns the primary role is known as the primary database 110, and its copy of the database is the current database (represented by the components of the database). The partner that owns the secondary role is known as the secondary database 150, and its copy of the database is the current mirrored database. However, while the present discussion refers to a primary and secondary database, it should be appreciated that the roles of the devices holding primary and secondary database can be reversed (e.g. role switching, the primary database is the mirrored database and the secondary database is the primary database, or instances where both databases are active and can serve different clients at the same time). The terms primary and secondary are provided solely for the understanding of the present structure.

Database mirroring involves redoing every insert, update, and delete operation that occurs on the primary database onto the secondary database as quickly as possible. Redoing is accomplished by sending a stream of active transaction log records to the secondary database, which applies log records to the secondary database, in sequence, as quickly as possible. Unlike replication, which works at the logical level, database mirroring works at the level of the physical log record. In some implementations, the primary database compresses the stream of transaction log records before sending it to the secondary database. This log compression occurs in all mirroring sessions. In some implementations, such as mirroring at the operating system level the actual changed or inserted record is sent from the primary database to the secondary database, as opposed to the log records.

A database mirroring session runs with either synchronous or asynchronous operation. Under asynchronous operation, the transactions commit without waiting for the secondary server to write the log to disk, which maximizes performance. Under synchronous operation, a transaction is committed on both partners, but at the cost of increased transaction latency. In some embodiments there are two mirroring operating modes. One of them, high-safety mode supports synchronous operation. Under high-safety mode, when a session starts, the secondary server synchronizes the secondary database together with the primary database as quickly as possible. As soon as the databases are synchronized, a transaction is committed on both partners, at the cost of increased transaction latency.

The second operating mode, high-performance mode, runs asynchronously. The secondary server attempts to keep up with the records sent by the primary server. The secondary database might lag somewhat behind the primary database. However, typically, the gap between the databases is small. However, the gap can become significant if the primary server is under a heavy work load or the system of the secondary server is overloaded. In high-performance mode, as soon as the primary server sends a log record to the secondary server, the primary server sends a confirmation to the client. It does not wait for an acknowledgement from the secondary server. This means that transactions commit without waiting for the secondary server to write the log to disk. Such asynchronous operation enables the primary server to run with minimum transaction latency, at the potential risk of some data loss.

In order for the synchronization between the primary and the secondary databases to occur, these databases need to maintain a constant communication or connection with each other. In the above mirroring approaches the primary server and the secondary server maintain communication with each other. The databases assume, as the connection between remains intact, that the data sent to the secondary database will be committed. However, when the connection between the primary and the secondary is somehow lost, updates from the primary to the secondary are not made, but need to be made following the restoration of the connection between the primary database 110 and the secondary database 150. To monitor the connection between the primary and the secondary the system 100 includes a connection manager 160. The connection manager 160 is a component of the system 100 that determines that the connection between the primary and the secondary is operational. In some embodiments, the connection manager 160 monitors the health of the connection. In this embodiment the characteristics of the connection is monitored, (e.g. speed, transmission rate, quality, etc.). These characteristics can be compared to a threshold value for the characteristics. Based on the comparison the connection monitor can determine the connection is not operational, despite the connection still existing. When the connection is determined not to be operational the connection manager 160 can initiate a change tracking procedure on the primary database. In some embodiments, the connection manager 160 is a component of the primary database 110. However, in other embodiments the connection manager 160 is remote from both the primary and the secondary databases 110 and 150, operating as a witness to the connection between the primary and the secondary. In this embodiment, the connection manager 160 is connected to both the primary and the secondary databases. In contrast to a standard witness, the connection manager 160 does not initiate a failover when the connection between the primary and the secondary, and between the witness and the primary, is broken, but initiates a change tracking process when the connection between the connection manager 160 and the secondary is broken. This can be in conjunction with a loss of the connection between the primary and the secondary or simply between the connection manager 160 and the secondary.

When initiated by the connection manager 160, a change manager 170 begins the change tracking procedure that tracks changes to the records in the primary database (e.g. changes to rows in tables 114). However, instead of using the log 130 to track the changes during the period of time of the connection loss, the technique used by the change manager 170 uses an indicator within the metadata 140 of a row in the database to indicate that a mirrored or copied image of the row does not match the source row. This metadata 140 is queriable, as though it were a field within a record, so that it can be quickly and efficiently retrieved, and the contents of the record can be mirrored into the mirror or copy of the row when the connection is restored with the secondary. For example, when the system 100 implements DB2 within a row for i database is a very small amount of storage allocated for metadata 140, information about the individual row that is used internally in the operating system. The process of the change manager 170 allocates space within this internal metadata 140, space for an indicator that indicates that data associated with the row has been changed. In some embodiments this allocated space is a single bit or byte within the metadata 140. As there was space already unused within the metadata 140, adding this change indicator does not increase the size of the row or the size of the file containing the row or collection of rows. This change indicator is used to track rows that need to be changed on a mirrored system when the mirrored connection has been lost. Again, this typically occurs because the mirrored system has suffered an outage of some sort. This change indicator within the row metadata 140 is configured to be queried, just as though it was a field in the record. As such it is possible to determine the quantity of records as well as which specific records need to be sent to the mirror system once that system is back on line without having to resort to the log. In databases that do not have row metadata 140, a single byte of metadata 140 would need to be added to the row. This can be done for example, in the form of a hidden column. However, other approaches can be used to add this single byte to the database, depending on the particular database management system employed by the system 100. This approach incurs no storage overhead for databases that already have metadata 140 in each row, and 1 byte for those that do not, by eliminating the need to store copies of the changed row.

When mirroring data bases between two partitions or computer systems, when one system experiences an outage (e.g. the secondary system), the other system remains active (e.g. the primary system), and rows may continue to be queried, updated, inserted and deleted from the database on the primary system. However, once the secondary system is back up, before it can be made available to the user, the rows in the database must be synchronized with the rows on the primary system before the secondary system can come back on line. In order to accomplish this, the entire database can be refreshed, effectively save the entire database, or at least the changed files, off the primary system and restore them to the target system. But this is a time consuming and data-intensive operation, and potentially has run time performance consequences while logging is active.

When the connection with secondary database 150 is restored the connection manager 160 executes a procedure to cause the change manager 170 to send only the parts of the database that has changed. That is the rows that have changed while the connection was broken. However, in some embodiments another component of the database 110 can send this information. Also, the connection manager 160 can instruct the change manager 170 to stop tracking changes via the change indicator. Using the change indication discussed above, this indicator of the change or “out of syncness” is within the row, if the row goes to disk or other storage, so does that indicator. This ensures that the “out-of-syncness” of the row survives an outage on the source system without incurring any additional writes and affecting performance. Additionally, as this change indicator is queriable, it is possible to look at the indicator in SQL as though it were another just another column in the row, even if the row has been deleted. When a database table(s) must be mirrored between two systems, and a row is altered (inserted, updated or deleted) on one system, it must also be altered on the other system.

In some embodiments when the primary database 110 makes a change to a row, it sends that change to the secondary database 150. If the change cannot be sent to the target system, or it fails on the target system for any reason, the database stores the out-of-sync indicator in the row at the same time. A count of the number of out-of-sync rows can also be maintained within the table (or file). Once the secondary database 150 is available to the primary system, the connection manager 160 can initiate a “re-synchronization process”. This process queries the “out-of-sync” count for a table to determine if there are rows within the table that need synchronization. In response if there are out-of-sync rows, the connection manager 160, change manager 170 or other component can query the table for those records that are out-of-sync and send them to the target system to be updated. Following the updating the change indicator within the row can be reset to normal once confirmation of the row change has been received from the secondary database.

This approach does not prevent any other user-initiated row changes from occurring during the resynchronization process. It should be noted that while the present discussion focuses on mirrored database systems, the change indicator can be used by other database operations in non-mirrored databases. For example, the out-of-sync indicator can permit the ability to copy or alter (add or remove columns) a table while it is active (i.e. not locking out other users using the database). This prevents missing any data changes by resyncing at the end of modification of the table. Again, most databases will lock users out of a table, preventing row updates to the table, while a table is being copied or altered. However, using this indicator, once the copy/alter process has begun, users can update rows while the copy/alter is in progress. When the user changes the row, the database (through the change manager 170, or other component) will see that a copy/alter is in progress, and mark the row as out of sync at the time of the update (or insert or delete) operation. Once all rows have been copied or altered, the copy/alter process can then go back and query the table for any rows that have the change indicator, and process those changed records to the copy of the table, marking each source row as unchanged (or in sync) after it is copied to the target copy table. This process is repeated to process the changed-rows into the copy of the table until such time as there are no more changed rows to process. In some embodiments if there are few enough changed rows that the copy/alter process can lock the table, process the last few remaining changed rows and then unlock the table. In this embodiment the row lock would be for a much shorter duration than locking the table for the duration of a full copy or alter. The number of rows for the reduced lock can be determined by the administrator of the database based on performance characteristics that the administrator desires. For example, this threshold could be as few as 2 rows, a 100 rows, or any other number of rows desired.

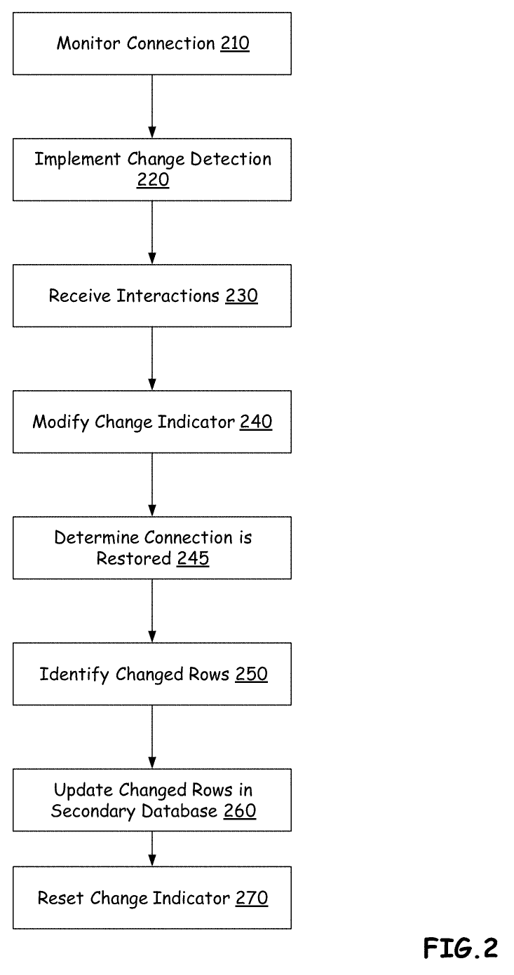

FIG. 2 is a flow diagram illustrating a process for tracking changes to data within a database system employing mirroring according to illustrative embodiments. The process begins by monitoring a connection between the primary database and the secondary database. This is illustrated at step 210. The monitoring of the connection can be done by a connection manager 160, such as connection manager 160. In this approach, the connection manager 160 can monitor the connection between the primary database and the secondary database, and determine whether the connection exists between the two is active. In some embodiments, the connection manager 160 can determine if the connection between the primary and the secondary databases is operating at or above a predetermined performance threshold. The connection manager 160 can be part of the primary database 110 or can be remote from the primary and the secondary databases. In some embodiments, another component of the system 100 can perform these functions.

When the connection manager 160 determines that the connection is not active between the primary and the secondary database, a change detection procedure is implemented. This is illustrated at step 220. The connection manager 160 causes the change manager 170 to start monitoring the primary database 110 for changes to the corresponding rows of the database.

Following the implementation of the change detection procedure, a user continues to interact with the primary database. This is illustrated at step 230. The user can perform all the functions on the database that are available to user when the system is fully operational, including the mirroring. As the user makes a change to a particular row in the primary database 110, a byte in the metadata 140 associated with that row is changed to indicate that the row is changed. This is illustrated at step 240. For example, the value of the change indicator can go from 0 to 1. Once the user has initiated a change to a particular row, the value of the change indicator does not change even if the user makes additional changes to the row after the initial change. In some embodiments as the user continues to make changes to the particular row, the change indicator in the metadata 140 can increment to indicate how many changes have been made to a particular row. In this embodiment, additional information can be extracted from the single change indicator that may be informative or useful to an administrator. In some embodiments, the change indicator is not contained in the metadata 140 of the database, but as column in the database itself. In some embodiments the column is a hidden column. When the change indicator exists in the database itself, it is modified and behaves similarly to when the change indicator exists in the actual metadata 140 for the database. The process of step 240 repeats for each row that is changed until such time as the connection between the primary database 110 and the secondary database 150 is restored.

Once the connection between the primary database 110 and the secondary database 150 is restored, the change detection stops. This is illustrated at step 245. Next the process queries the primary database 110 to identify all of the rows that have changed since the outage. This is illustrated at step 250. The query simply queries either the metadata 140 or the row holding the change indicator, for records that have a value indicating that the row has been changed. Any method for querying the database can be used. The results of the query are then provided to the change manager 170.

The change manager 170 receives the results of the query and causes the rows that were changed to be updated in the secondary database 150. This is illustrated at step 260. In some embodiments, the change manager 170 is configured such that it can directly implement the updating of the changed records in the secondary database 150. However, in other embodiments, the change manager 170 simply implements the normal process for updating records between the instances. Each record that is listed in the query as having been changed is updated with the current data in that record. Any intermediate changes that occurred to that record are not copied into the secondary database 150. As such, only the latest data is transferred, and all transactions are not replayed to the secondary database.

Following the transfer of each row that includes the change indicator to the secondary database 150, the change manager 170 resets the change indicator back to its original value. This is illustrated at step 270. In some embodiments, the reset of the change indicator to its original is performed after all of the changed records are copied to the secondary database 150. However, in other embodiments the resetting occurs at the time the databases are locked for the transfer of the data associated with the changed rows. Following the resetting of the change indicator, the process returns back to step 210 and monitors the connection.

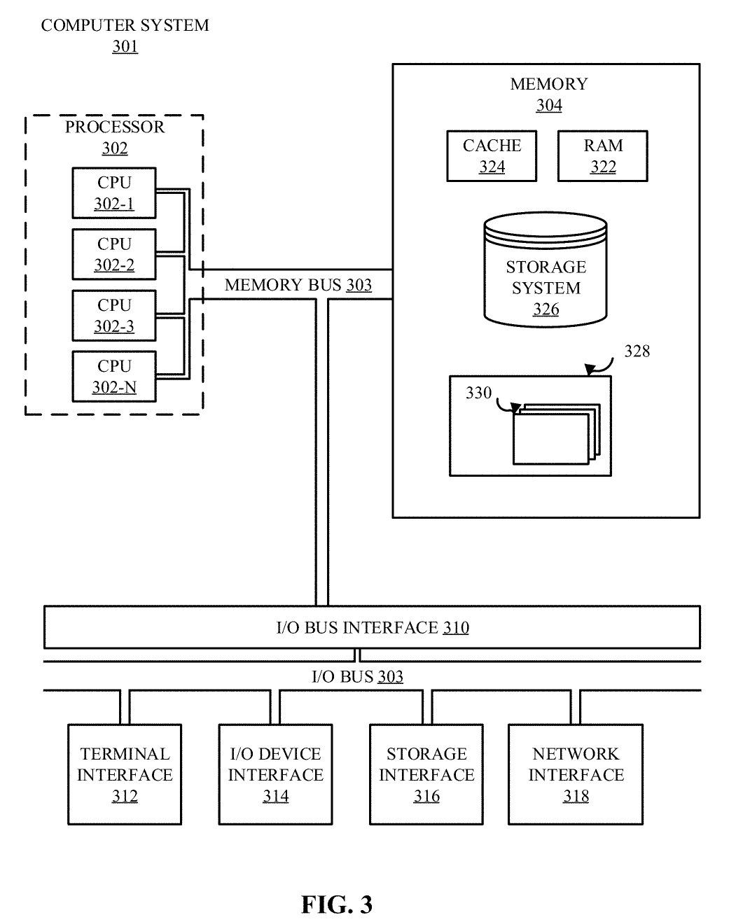

Referring now to FIG. 3, shown is a high-level block diagram of an example computer system 301 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 301 may comprise one or more CPUs 302, a memory subsystem 304, a terminal interface 312, a storage interface 316, an I/O (Input/Output) device interface 314, and a network interface 318, all of which may be communicatively coupled, directly or indirectly, for inter-component communication via a memory bus 303, an I/O bus 308, and an I/O bus interface unit 310.

The computer system 301 may contain one or more general-purpose programmable central processing units (CPUs) 302-1, 302-2, 3023, 302-N, herein collectively referred to as the CPU 302. In some embodiments, the computer system 301 may contain multiple processors typical of a relatively large system; however, in other embodiments the computer system 301 may alternatively be a single CPU system. Each CPU 302 may execute instructions stored in the memory subsystem 304 and may include one or more levels of on-board cache.

System memory 304 may include computer system readable media in the form of volatile memory, such as random access memory (RAM) 322 or cache memory 324. Computer system 301 may further include other removable/non-removable, volatile/non-volatile computer system storage media. By way of example only, storage system 326 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 304 can include flash memory, e.g., a flash memory stick drive or a flash drive. Memory devices can be connected to memory bus 303 by one or more data media interfaces. The memory 304 may include at least one program product having a set (e.g., at least one) of program modules that are configured to carry out the functions of various embodiments.

Although the memory bus 303 is shown in FIG. 3 as a single bus structure providing a direct communication path among the CPUs 302, the memory subsystem 304, and the I/O bus interface 310, the memory bus 303 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 310 and the I/O bus 308 are shown as single respective units, the computer system 301 may, in some embodiments, contain multiple I/O bus interface units 310, multiple I/O buses 308, or both. Further, while multiple I/O interface units are shown, which separate the I/O bus 308 from various communications paths running to the various I/O devices, in other embodiments some or all of the I/O devices may be connected directly to one or more system I/O buses.

In some embodiments, the computer system 301 may be a multi-user mainframe computer system, a single-user system, or a server computer or similar device that has little or no direct user interface, but receives requests from other computer systems (clients). Further, in some embodiments, the computer system 301 may be implemented as a desktop computer, portable computer, laptop or notebook computer, tablet computer, pocket computer, telephone, smart phone, network switches or routers, or any other appropriate type of electronic device.

It is noted that FIG. 3 is intended to depict the representative major components of an exemplary computer system 301. In some embodiments, however, individual components may have greater or lesser complexity than as represented in FIG. 3, components other than or in addition to those shown in FIG. 3 may be present, and the number, type, and configuration of such components may vary.

One or more programs/utilities 328, each having at least one set of program modules 330 may be stored in memory 304. The programs/utilities 328 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 328 and/or program modules 330 generally perform the functions or methodologies of various embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

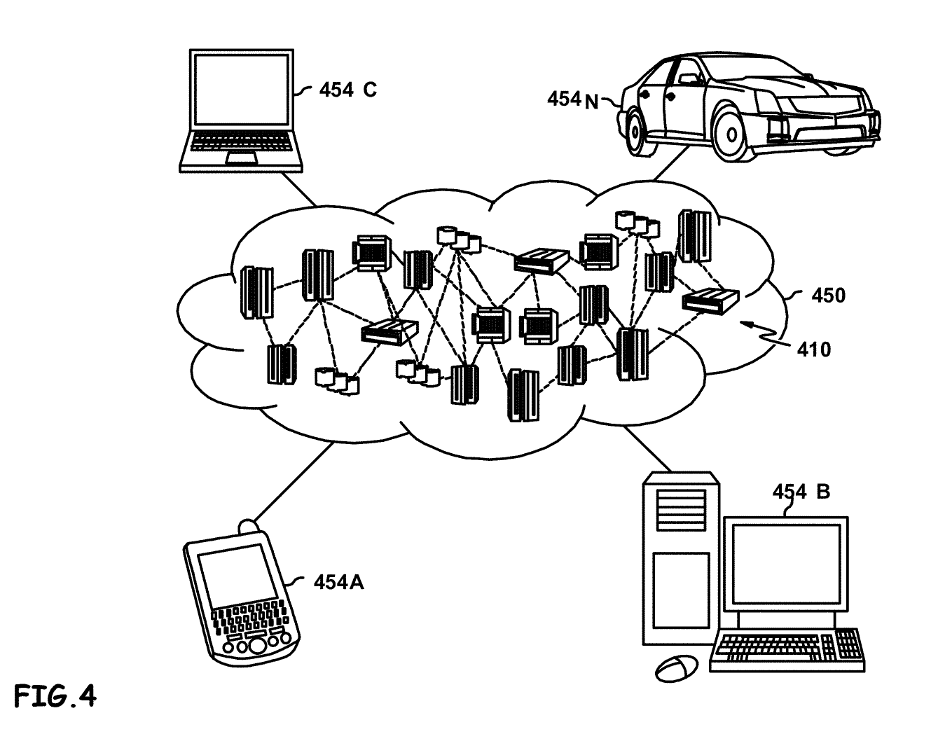

The system 50 may be employed in a cloud computing environment. FIG. 4, is a diagrammatic representation of an illustrative cloud computing environment 450 according to one embodiment. As shown, cloud computing environment 450 comprises one or more cloud computing nodes 95 with which local computing devices used by cloud consumers, such as, for example, personal digital assistant (PDA) or cellular telephone 454A, desktop computer 454B, laptop computer 454C, and/or automobile computer system 454N may communicate. Nodes 95 may communicate with one another. They may be grouped (not shown) physically or virtually, in one or more networks, such as Private, Community, Public, or Hybrid clouds as described hereinabove, or a combination thereof. This allows cloud computing environment 450 to offer infrastructure, platforms and/or software as services for which a cloud consumer does not need to maintain resources on a local computing device. It is understood that the types of computing devices 454A-N shown in FIG. 4 are intended to be illustrative only and that computing nodes 5 and cloud computing environment 450 may communicate with any type of computerized device over any type of network and/or network addressable connection (e.g., using a web browser).

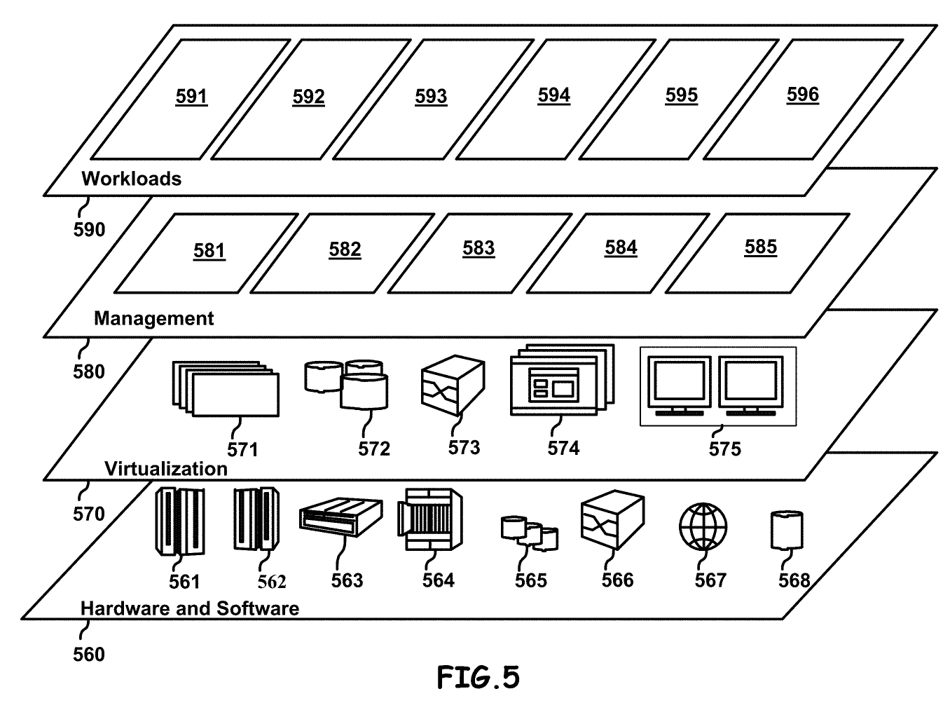

Referring now to FIG. 5, a set of functional abstraction layers provided by cloud computing environment 450 (FIG. 4) is shown. It should be understood in advance that the components, layers, and functions shown in FIG. 5 are intended to be illustrative only and embodiments of the disclosure are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provide pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; layout detection 593; data analytics processing 594; transaction processing 595; and database 596.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for updating a mirrored database system comprising:
monitoring a connection between a primary database and a secondary database, wherein the secondary database is a mirrored version of the primary database;
detecting a loss of the connection between the primary database and the secondary database;
in response to the loss of the connection, monitoring the primary database for changes;
detecting at least one modification to at least one row in the primary database;
for each detected modification in the database, changing a value of a change indicator associated with a corresponding row to indicate the corresponding row has been modified;
detecting a restoration of the connection between the primary database and the secondary database;
querying the primary database for the value of the change indicator indicating the corresponding row has been modified to obtain a current value for data in the corresponding row of the primary database; and
updating the corresponding row in the secondary database with the current value for the corresponding row of the primary database.

2. The method of claim 1 further comprising:
resetting, following updating, the value of the change indicator for each row back to a default value, the default value indicating an unmodified row.

3. The method of claim 2 wherein resetting occurs simultaneously with the updating of the corresponding row in the secondary database.

4. The method of claim 2 wherein resetting occurs upon a locking of a portion of the primary database.

5. The method of claim 1 wherein the change indicator is maintained within metadata for the corresponding row.

6. The method of claim 1 wherein the change indicator is a hidden column within the primary database.

7. The method of claim 1 wherein the change indicator is a single byte of data.

8. The method of claim 1 wherein the change indicator is a single bit of data.

9. The method of claim 1 wherein the loss of connection is based upon a performance threshold for the connection.

10. The method of claim 1 wherein the at least one modification is a deletion of a row in the primary database.

11. The method of claim 1 wherein the updating is performed without using a log associated with transactions performed on the primary database.

12. A database system comprising:
a primary database;
a secondary database communicatively coupled to the primary database, wherein the secondary database is a mirror of the primary database;
a connection manager configured to monitor a connection between the primary database and the secondary database, the connection manger further configured to initiate a change detection process upon a loss of the connection between the primary database and the secondary database;
a change manager configured to monitor the primary database for modifications made to the primary database, and to change a value associated with change indicator associated with a corresponding row in the primary database; and
wherein the connection manager is further configured to cause the change manager to send to the secondary database only a current value for data in the corresponding rows of the primary database having the value of the change indicator indicating the corresponding row has been modified upon a determination that the connection has been restored.

13. The database system of claim 12 wherein the change indicator is disposed within metadata of each row of the primary database.

14. The database system of claim 13 wherein the change indicator is a single byte.

15. The database system of claim 13 wherein the change indicator is a single bit.

16. The database system of claim 12 wherein the change indicator is disposed as a hidden column in the primary database.

17. The database system of claim 12 wherein the change manager is further configured to reset the change indicator to a default value following transmission of the current value for data to the secondary database.

18. The database system of claim 12 wherein the change indicator indicates a number of modifications made to the corresponding row in the primary database.

19. A computer program product having computer executable instructions that when executed cause at least one computing device to execute a method for updating a mirrored database system comprising:
monitoring a connection between a primary database and a secondary database, wherein the secondary database is a mirrored version of the primary database;
detecting a loss of the connection between the primary database and the secondary database;
in response to the loss of the connection, monitoring the primary database for changes;
detecting at least one modification to at least one row in the primary database;
for each detected modification in the database, changing a value of a change indicator associated with a corresponding row to indicate the corresponding row has been modified;
detecting a restoration of the connection between the primary database and the secondary database;
querying the primary database for the value of the change indicator indicating the corresponding row has been modified to obtain a current value for data in the corresponding row of the primary database; and
updating the corresponding row in the secondary database with the current value for the corresponding row of the primary database.

20. The computer program product of claim 19 wherein the updating is performed without using a log associated with transactions performed on the primary database
